(19) United States
(12) Patent Application Publication
(10) Pub. No.: US 2015/0083705 A1
(43) Pub. Date: Mar. 26, 2015

(54) METHOD AND SYSTEM FOR HEATING GARMENTS AND HEATED GARMENTS INCORPORATING SAME

(71) Applicant: Gerbings, LLC, Stoneville, NC (US)

(72) Inventors: Charles E. Cronn, Fort Lee, VA (US); Kayla Stevens, Greensboro, NC (US); Cupid Roberts, Stoneville, NC (US)

(21) Appl. No.: 14/496,603

(22) Filed: Sep. 25, 2014

Related U.S. Application Data
(60) Provisional application No. 61/882,319, filed on Sep. 25, 2013.
(60) Provisional application No. 61/885,246, filed on Oct. 1, 2013.
(60) Provisional application No. 61/882,247, filed on Sep. 25, 2013.
(60) Provisional application No. 61/885,166, filed on Oct. 1, 2013.

(51) Int. Cl. H05B 3/34; A41D 19/015

(52) U.S. Cl. CPC H05B 3/342; A41D 19/01535
USPC 219/211; 219/549; 219/481

(57) ABSTRACT

A heated garment is disclosed for use by a wearer to impart heat to the wearer in cold conditions. The heated garment includes a wearable garment having an interior portion that resides adjacent a wearer's body. At least one heating pad is disposed in the wearable garment and the heating pad is configured, when heated, to radiate heat from the interior portion of the garment to a wearer. The heating pad comprises at least one heating element fixed to or otherwise incorporated into a flexible carrier. The heating element is configured on the carrier such that, when heated, the heating element produces on the carrier a field of warmth characterized by a plurality of areas of increased thermal energy relative to other areas on the carrier. A power supply is configured to supply operating voltage to the heating element when heat is desired and a controller is used to control the power supply.

### RELATED APPLICATIONS

Priority is hereby claimed to the filing dates of the following U.S. provisional patent applications: 61/882,319 entitled Resistive Heating Device, filed on Sep. 25, 2013; 61/885,246 entitled Resistive Heating Device having an Integrated Sensor, filed on Oct. 1, 2013; 61/882,247 entitled Silicone Impregnated Heating Element for a Heated Garment and Related Method, filed on Sep. 25, 2013; and 61/885,166 entitled Electrically-Powered Thermal-Regulated Apparel Controller, System, and related methods, filed on Oct. 1, 2013, each of which provisional patent applications are incorporated by reference as if set forth fully herein.

### TECHNICAL FIELD

This disclosure relates generally to garments, clothing, and apparel and more specifically to garments having active electrical heating elements for imparting warmth to the body of a wearer.

### BACKGROUND

Heated clothing has been available for some time to impart supplemental warmth to wearers in cold weather. Such clothing has included for example jackets, coats, pants, boots, gloves, and other active wear and specialty items. Some heated clothing utilizes replaceable chemical heating packets inside the clothing while others, such as those disclosed in U. S. patent publication 2008/0223844 for instance, provide heat through electric heating pads incorporated into the clothing. These solutions can indeed provide significant total heat for warming the body of a wearer. However, they tend to be inefficient and somewhat ineffective. Some generate a blanket of heat that is applied over a wide area of a wearer's body resulting in wasted heat in areas that do not necessarily need to be warmed. In other cases, warmth is conveyed to a wearer in small separated patches or regions. In order to warm regions of the wearer's body outside these heated regions, a wearer sometimes must cause excessive heat to be generated by the patches, which can result in splotchy overheating and even burning of the wearer's skin. In the case of electric heating pads, these inefficiencies equate either to a requirement for larger more bulky batteries or a shorter battery life before recharging is required.

Some heated clothing in the past has been particularly vulnerable to damage or destruction by environmental hazards. This has particularly been true of heated work gloves, which often are subjected to harsh environments, moisture, chemicals, hot surfaces, and other hazards. Previously, it has not been uncommon for expensive heated work gloves to wear out or quit working and the only viable solution has been to discard them in favor of a new pair of heated gloves. This is expensive, inefficient, and frustrating for a wearer.

A need exists for a heated garment and for a heating system for garments that can provide a wearer with a uniform and comfortable perception of warmth and do so efficiently and effectively using less electrical energy. A need also exists for a heated garment that is more rugged and less likely to be damaged or destroyed by harsh working environments. Addressing these and other needs within the heated garment industry is one of the primary objectives of the methods and systems disclosed herein.

### SUMMARY

The entire disclosures of the provisional patent applications to which priority is claimed above are hereby incorporated by reference in their entireties.

A heated garment and a heating system for incorporation into garments are disclosed. The heated garment is configured for use by a wearer to impart heat and warmth to the user in cold conditions the heated garment includes a wearable garment having an interior portion and an exterior portion. The garment may be a jacket, pants, gloves, footwear inserts, a hat, or other article of clothing. At least one heating pad is incorporated into the wearable garment and includes a flexible fabric carrier and a heating element fixed to or incorporated into the carrier. The heating element can be an elongated conductive wire having a predetermined resistance per unit length and stitched to the carrier. Alternatively, the heating element can be conductive yarn or thread embroidered or otherwise sewn into the fabric of the carrier.

The heating pad is configured so that when it is heated through connection to an electrical power supply, heat is radiated from the interior portion of the garment to a wearer of the garment. Furthermore, the heating element on the carrier is configured or laid out on the carrier such that, when heated, the heating element produces on the carrier a field of heat characterized by a plurality of discrete areas of increased thermal energy relative to average thermal energy created within the field. In one embodiment, this is accomplished by arranging the heating element to cross over itself within the areas of increased thermal energy to increase the thermal mass within these areas. In another embodiment, the heating element is arranged such that is repeatedly passes close to itself within the areas of increased thermal energy. Regardless, the thermal energy, meaning the capacity to transfer heat, in the vicinity of the increased thermal mass, is increased. It has been found that the increased heat transfer rate (heat flux) in these areas conveys to a wearer the perception of increased warmth compared to a uniformly heated field for a given electrical power consumption.

A source of electrical operating voltage is arranged to supply operating voltage to the heating element when heat is desired. A controller may be coupled to the voltage source to control the characteristics of the voltage applied to the heating element and thereby to regulate the heat provided to a wearer in a given environment. The above and other features, aspects, and advantages of the invention disclose herein will become more apparent to those skilled in the art upon review of the detailed description set forth below taken in conjunction with the accompanying drawing figures, which are briefly described as follows.

### BRIEF DESCRIPTION OF THE DRAWINGS

FIG. 1 is an inside plan view of a heating device or pad for heated clothing incorporating principles of the present disclosure in one preferred form.

FIG. 2 is an outside plan view of the heating device or pad for heated clothing illustrated in FIG. 1.

FIG. 3 is a front view of a garment incorporating the heating device or pad illustrated in FIGS. 1-2.

FIGS. 4A-4D are schematic illustrations of other conductive fiber embroidered patterns that can be used to form a heating pad or device incorporating the principles of the present invention.

FIG. 5 illustrates interconnection of multiple heated garments incorporating the heating system of the present invention and one example embodiment of the relationship of the controller to the garments.

FIGS. 6A-6C are perspective views of a heating device or pad according to the disclosure including a silicone impregnated carrier to provide protection and insulation.

FIG. 6D is an end view of a glove finger sheath incorporating a heating element according to the disclosure.

FIG. 7 is a schematic of one example circuit for the heating system according to the principles of the present invention.

FIGS. 8A-8C illustrate example embodiments of a controller for the heating system according to the principles of the present invention.

### DETAILED DESCRIPTION

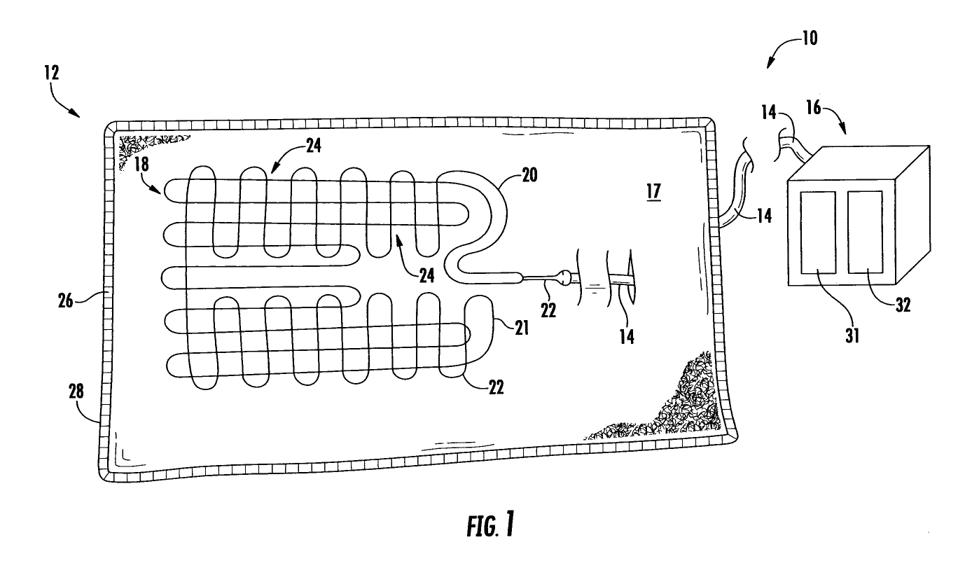

Referring now in more detail to the drawing figures, wherein like reference numbers indicate like parts throughout the several views, FIGS. 1-3 illustrate a heating device 10 for incorporation into a heated garment. The heating device 10 includes a heating pad 12 and an apparel controller unit 16 (FIG. 1). The heating pad 12 comprises a flexible preferably substrate, such as a flexible fabric carrier 17 into which is incorporated a heating grid 18. The heating grid 18 is formed by an elongated electrically conductive heating element or wire 20 having a predetermined resistance per unit length. The heating element may be attached to the flexible carrier 17 by appropriate stitching 22. Electrical connector 22 is electrically coupled to the ends of the heating element 22 and connects the heating element to the apparel controller unit 16. The apparel controller unit 16 applies an operating voltage to the heating element that can be controlled as described in more detail below to cause the heating element 22 to be heated in response to current flow through the resistive heating element.

The heating element 20 is routed and configured on the carrier 17 so that upon application of an operating voltage, the heating element produces a field of warmth that is characterized by isolated areas of higher thermal energy (i.e., the ability to sustain a larger heat flux) within the field. In the embodiment illustrated in FIG. 1, the heating element is configured on the carrier so that it crosses over itself numerous times at intersections 24. When the heating element 20 is heated through application of an operating voltage, its increased temperature becomes substantially uniform along its length. Accordingly, the field of warmth produced by the heating element is substantially the same temperature throughout its extent. However, the thermal energy (which is the amount of heat available to be transferred and can be calculated as mass multiplied by specific heat), is significantly higher at the intersections 24. This is due at least in part because twice the mass of heating element 20 is present at these intersections than at other locations within the field of heat.

When the heating pad 12 is incorporated within a garment such as a jacket or coat, it resides next to a wearer's body. When activated by an operating voltage, the field of heat produced by the heating element 20 transfers heat from the heating pad to the wearer's body providing a sensation of warmth to the user. However, an increased heat flux occurs at the intersections 24 due to the higher thermal energy at these intersections. It has been discovered that this phenomenon provides the wearer with a perception of increased warmth from the heating pad compared to the perception of warmth that is felt from a field of uniform thermal energy. Accordingly, with the present invention, a wearer can be provided with a heightened perception of warmth for a given operating voltage and actual temperature of the heating element itself.

Carrier 17 may be made of any of a variety of thermally stable woven or non-woven materials with sufficient flexibility for inclusion in a garment. Examples are woven fabric, non-woven sheet, various flexible plastics, and heavy paper. The heating element 20 may comprise a coated conductive wire or other suitable conductive strand having a resistance per inch suitable for generating a heat output of 5-100 watts per inch (W/in). Appropriate conductive wire, filaments, fibers or other materials may include copper, zinc, ni-chrome, silver, nickel, alloys thereof, and combinations thereof. Impurities may be added as appropriate to adjust the resistance per unit length of the wire. Preferably, the resistance is balanced such that the target heat output is generated by application of an operating voltage ranging from about 1.5 volts to about 28 volts and a resulting current ranging from about 5 mA to about 100 mA.

In the illustrated embodiment, the heating element 20 is arranged on the carrier such that isolated areas of increased thermal energy are generated within the field of heat. One such configuration is shown in FIG. 1 as a grid 18 formed by a single elongated wire heating element 20 coupled to carrier 17 by stitching 22. The heating element is arranged in an intersection pattern so as to cross over itself at intersections 24 where the isolated areas of increased thermal energy are created. In this embodiment, the carrier 17 is attached to other components of the device along an edge 26 by stitching 28; although other attachment mechanisms may be used.

The grid 18 is defined in this embodiment by roughly evenly spaced wire segments 21 extending generally orthogonally with respect to each other to define intersections 24. This example configuration provides increased thermal energy in the areas of the intersections 24 compared to a lower average thermal energy of the entire heat field when the heating device 10 is in use. This allows for higher heat transfer to a wearer's body within the areas of the intersections for a given operating voltage applied to heating element 20, which as mentioned above, provides the user with an enhanced perception of warmth compared to a field of uniform thermal energy.

Higher thermal energy within the isolated areas yields an increase in the rate of heat transfer per unit area, referred to as thermal flux, to a wearer's body in these areas. This is due in part because thermal flux is proportional to the difference in thermal energy between two conductive bodies. The thermal flux is greater when a higher thermal energy gradient is maintained, regardless of the power consumption of the heating element. When the present heating device is used in heated clothing, this can result in greater perceived warmth for a given operating voltage. The heating device 10, therefore, can allow for greater perceived warmth and improved comfort for a user compared to a conventional heating device that merely generates a field of substantially uniform thermal energy.

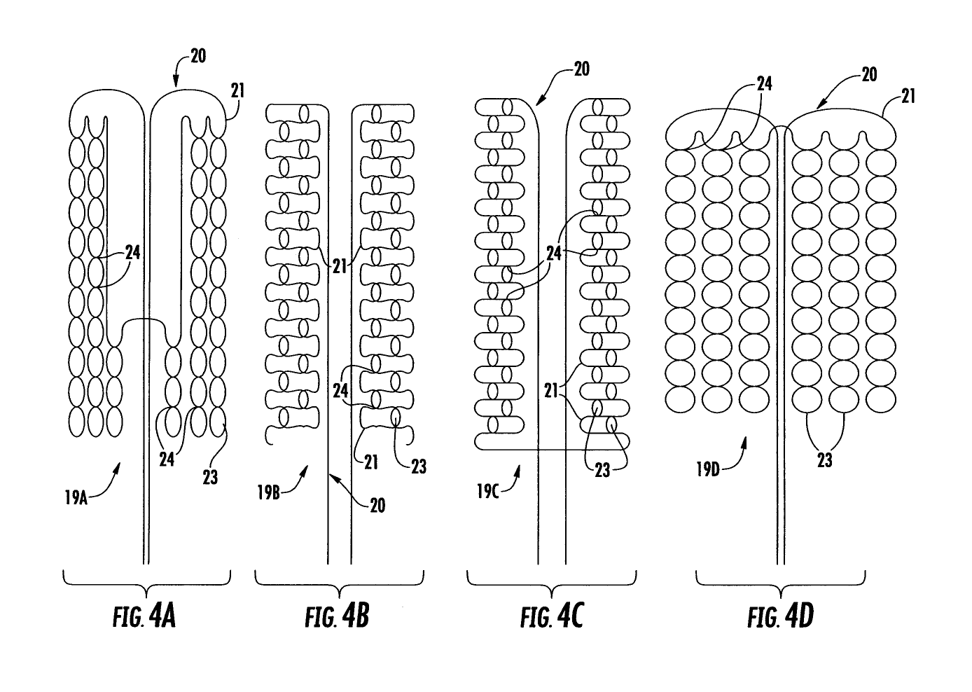

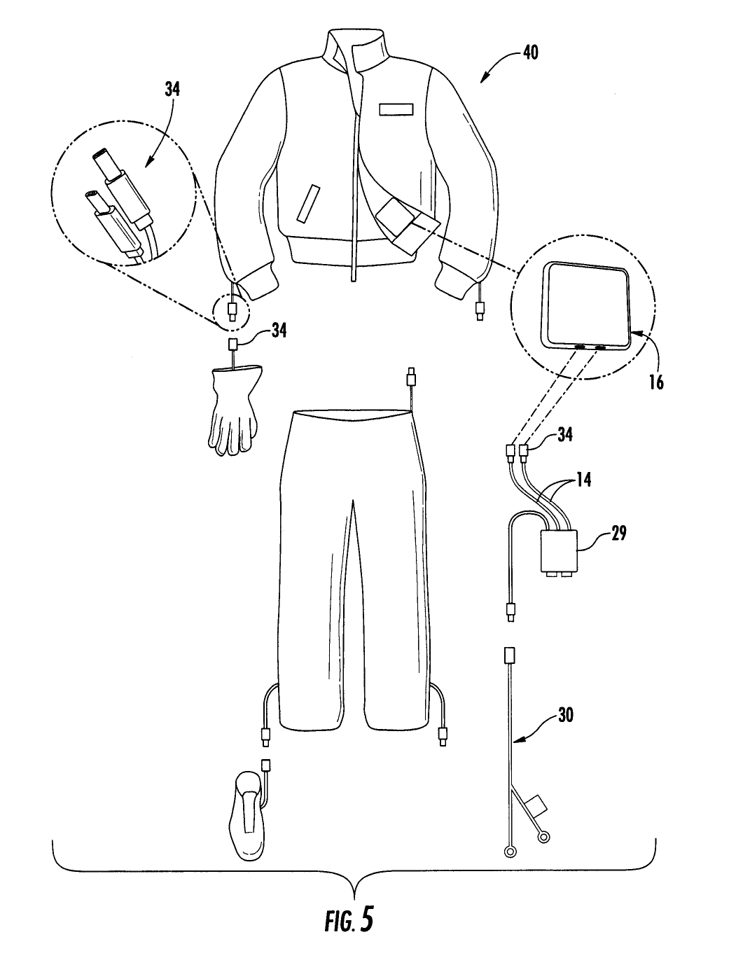

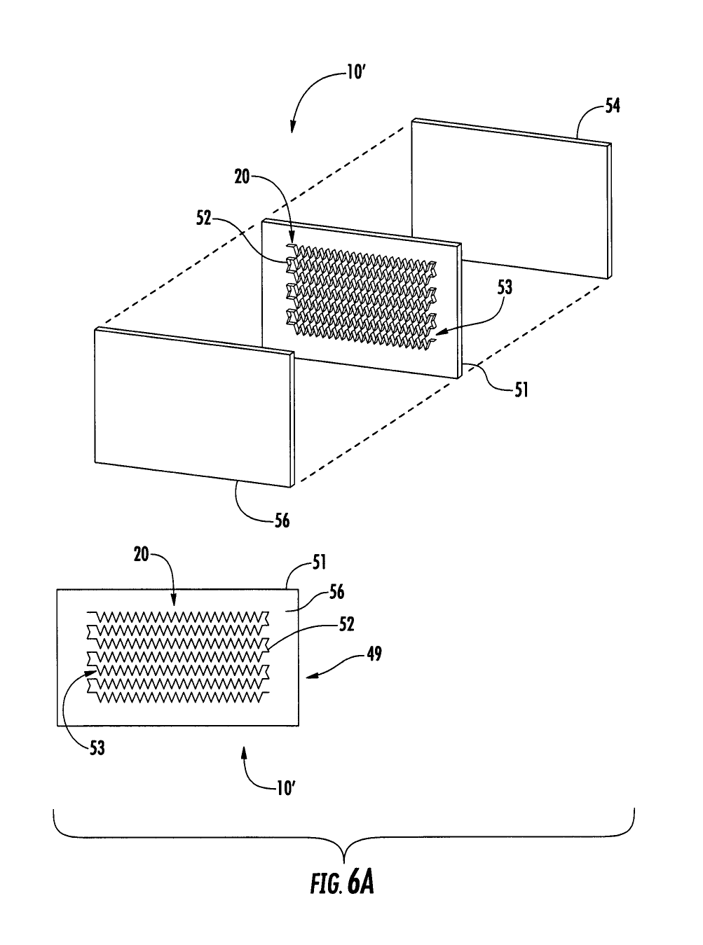

FIGS. 4A-4D illustrate still further possible thermal or heating element grid patterns 19A-19D, by which a conductive wire or heating element 20 is applied to a substrate material. The heating element or conductive wire 20 is shown being applied with a series of segments 21 or loops 23 that are arranged in an overlapping or tangentially connected relationship so as to define intersections 24, as discussed above.

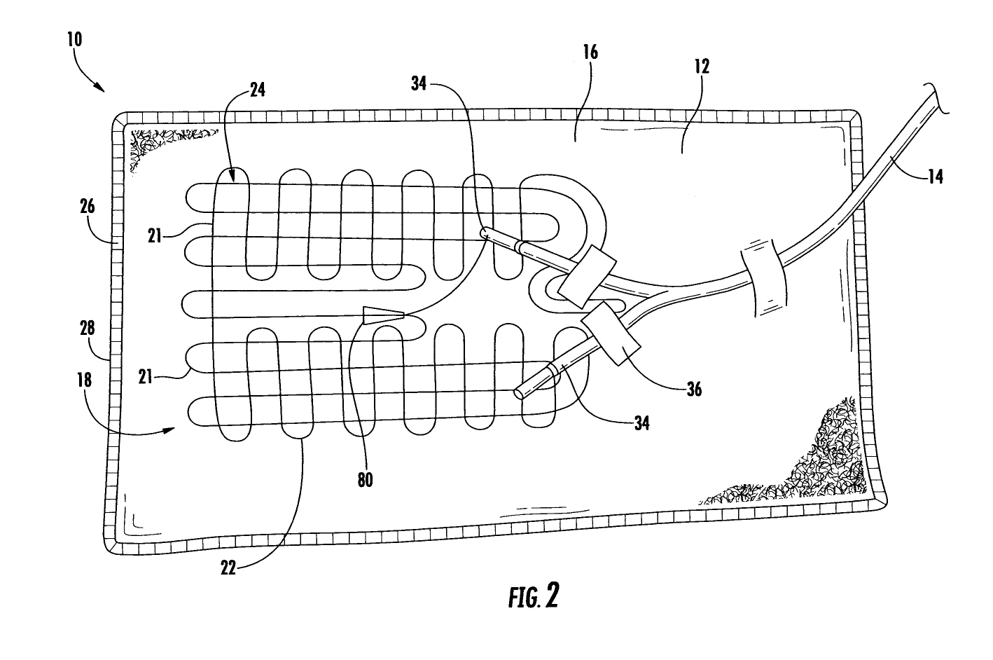

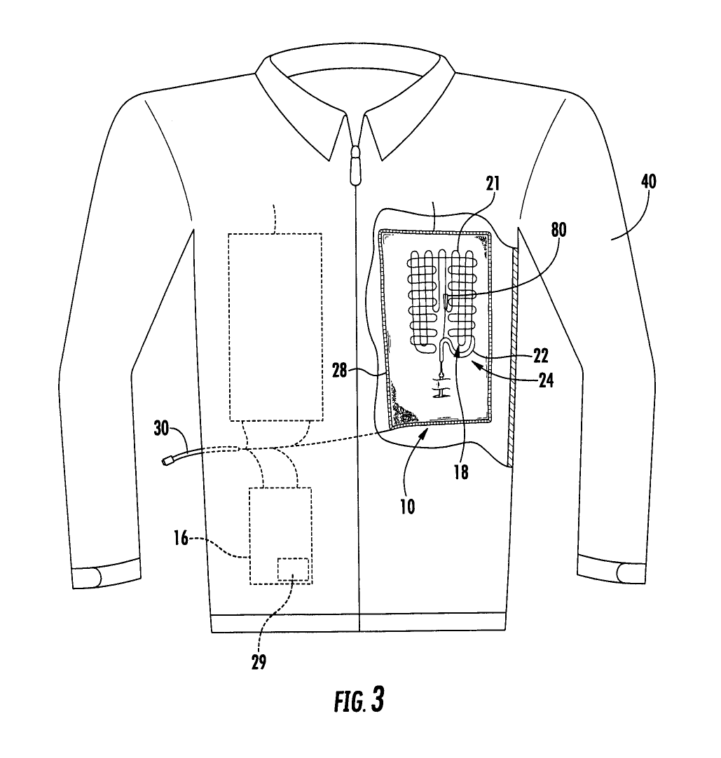

Heating element 20 may be coupled to an apparel controller unit 16 by a wire or similar connector 14 through which the apparel controller unit monitors and applies operating voltage to the heating element. As shown in FIG. 2, the unit 16 can be a separate unit or can be incorporated into the garment 40, as shown in FIG. 3, or can be connected to an external power source by a connector or conduit 30. The apparel controller unit also can include an internal power supply 29 and can include a power output display 31 and a power selector 32 by which the user can monitor and adjust the power setting. The apparel controller unit 16 and its mode of operation are designed such that far less expensive electronic components can be used to maintain a perception of warmth for a wearer that is initially selected by the wearer, as discussed below.

Referring to FIG. 2, the back of heating pad 12 includes a backing 33 which may be a woven or nonwoven fabric. In some embodiments, backing 33 comprises a woven nylon fabric. Preferably, regardless of the material selected, the backing 33 has low thermal conductivity such that is serves to insulate the heating element 20 from heat loss to the environment through the backing. This, in turn, tends to retain generated heat on the side of the carrier 17 that faces the body of a wearer when in use. Power wire 14 may be coupled to the heating element 20 by electrical couplings shown as wire connectors 34. Lead ends of power wire 14 and/or wire connectors 34 may be secured to backing 33 by a variety of means including stitching or tape segments 36.

In some embodiments, stitching 24 is used to secure the heating element 20 to the carrier 17. This stitching may also penetrate the backing 33 to attach the backing, carrier, and heating element together to form a unitary heating pad or device body 10. Stitching 28 along edge 26 also may be used to secure backing 33 to carrier 17.

Referring to FIG. 3, a garment 40, in this case a shirt or jacket includes a heating device or pad 12 according to principles of the present disclosure. While the garment 40 is shown as a shirt or jacket, it will be understood by the skilled artisan that other garments may incorporate the heating device of the present disclosure such as, for instance, gloves, hats, socks, pants, boots or other footwear, and inserts. The heating device 10 in FIG. 3 is incorporated into the interior of the garment 40 and resides next to the body or inner clothing layer of a wearer. The heating device 10 may be attached to the garment in a variety of ways including, without limitation, by being carried in a pocket, by being attached with hook-and-loop fasteners, or permanently stitched into the inner lining of the garment. In any event, the heating pad with its low thermal conductivity backing generates heat flux toward the body of the wearer and minimizes heat transfer in the opposite direction.

Referring to FIG. 5, examples of various thermal-regulated apparel items are shown. These examples include a jacket, glove, pants, and shoe insole. Each may be connected to each other in series for control and/or monitoring by a single apparel controller unit 16, or each may be directly linked to a separate or dedicated apparel controller unit therefor.

In an enhanced embodiment, the heating pad of the system can be impregnated with a material that protects the heating element and other components of the heating pad from damage as a result of abrasion, puncture, kinking, and other environmental hazards. While this enhanced embodiment may be applicable to heating pads for all types of garments, it is particularly useful for incorporation into heated gloves, which generally are more vulnerable to such hazards. Accordingly, this aspect of the invention will be described below in the context of gloves and their manufacture, although the invention certainly is not limited to gloves.

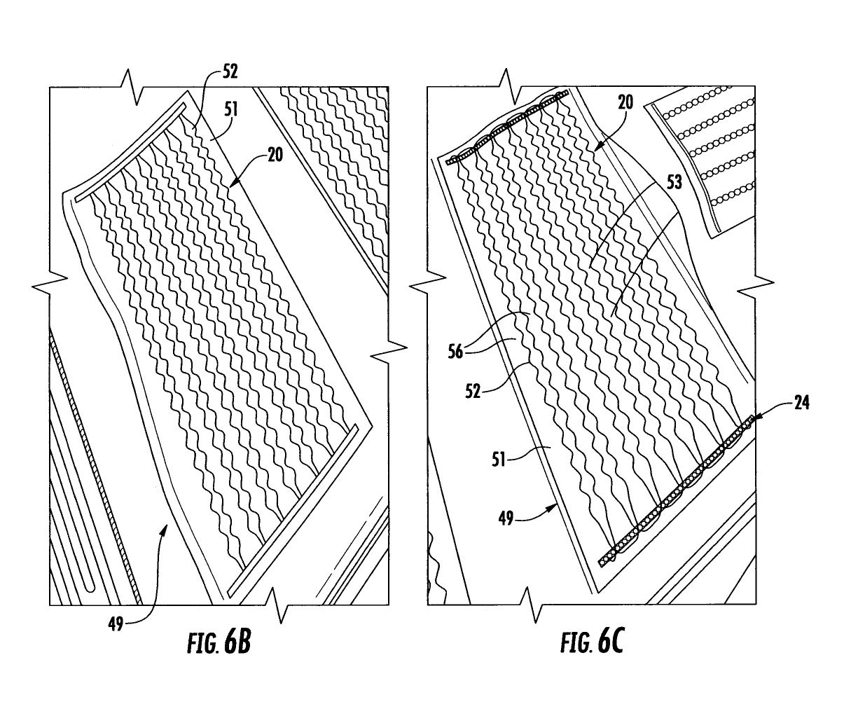

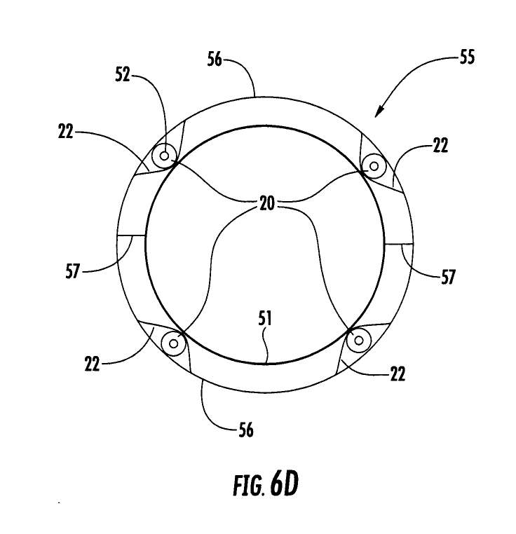

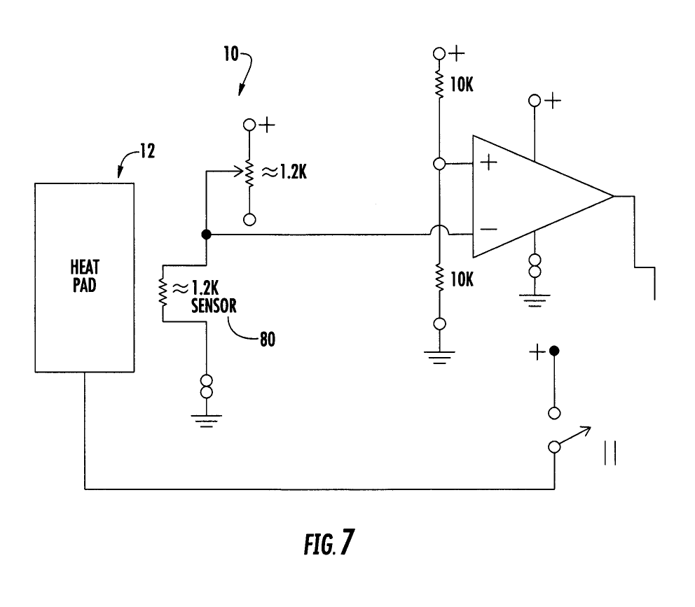

The heating element may be formed of various conductive materials as mentioned above, and also may comprise conductive textile yarns or other material that is coated, plated, impregnated, or chemically bonded with a conductive or semi-conductive material capable of conducting electricity. FIGS. 6A-6C illustrate a method of forming a coated or impregnated heating device 10′, here shown as a heating pad 49 that comprises a fabric carrier 51. A heating element 20, in the form of conductive yarns, filaments, fibers, wires or similar flexible heating elements 52 have been embroidered or stitched into the substrate fabric carrier 51 using automated multi-head sewing machinery. In this embodiment, rows of the conductive heating elements can be applied in a zigzag configuration such that areas of increased thermal density 53 are created within the field created by the heating elements 52, as illustrated in FIGS. 6A and 6C. As shown in FIG. 6A, the heating pad 49 can then be applied to a stabilizer 54, such as a woven or non-woven pad or substrate/backing, and can be impregnated with a liquid silicone layer 56, to provide physical protection and insulation as described in more detail below.

FIG. 6B illustrates a heating pad 49 prior to impregnation/application of the silicone thereto, while FIG. 6C illustrates the heating pad after impregnation. After the silicone material is applied/impregnated into the heating pad, such as by spraying, rolling, calendaring or other, similar method, it will be cured, for example, by heating at about 140°-160° F. for 2 hours.

According to this aspect, a heated glove can be formed which includes an inner glove layer and an outer glove layer. The inner glove layer defines a plurality of finger sheaths 55, as shown in FIG. 6D, with each finger sheath 55 generally being sized to receive one of a wearer's fingers. A heating element 20 is incorporated into each of the finger sheathes 55 and, in one embodiment, comprises one or more elongated heating elements coupled to or incorporated into the inner glove layer. The one or more heating elements form a heat-generating circuit within each of the finger sheaths when coupled to a source of operating voltage. According to the invention, the heating elements form electrical heating circuits extending substantially about the inner circumference of the finger sheaths.

The inner glove layer in this embodiment comprises a fabric carrier that serves as a physical structure for carrying the heating element or elements. The heating elements may be stitched to the fabric carrier to form part of the inner glove layer. The finger sheaths 55, each configured to receive one or more of a plurality of a wearer's fingers, are formed by folding and stitching a portion of the inner glove layer incorporating the fabric carrier 51 and heating elements 20 to form the generally cylindrical shape of the finger sheaths, after which the finger sheaths can be attached at seams 57. In this way, the heat-generating circuit extends substantially completely about an inner circumference of the one or more plurality of finger sheaths. The inner glove layer is then stitched into the outer glove layer to form the basic shape and configuration of the glove.

In some embodiments, the inner glove layer incorporating the carrier and heating elements may comprise any suitably flexible textile fabric. Heating elements have been successfully secured to a variety of fabric carriers with comparable results. For example, heating elements have been stitched to non-woven materials, nylon taffetas, polyester fleeces and a variety of other materials for use in the manufacture of heated gloves. Some materials such as certain polyesters for example lend themselves to use as a fabric carrier more readily than others. This is due at least in part to the automated stitching process that incorporates the heating element into the carrier, which may be more readily applied to a somewhat stiffer fabric. Also, some carrier materials have better thermal and/or electrical insulation properties than others, making them more desirable in the present application. It has been found that a single-sided polyester fleece material is a good choice because it is flexible, easily manipulated by automated stitching equipment, and is a good insulator against the loss of heat. However, some non-woven materials also may work well and all suitable materials are included within the scope of the invention disclosed herein.

The heating element can be metal or can comprise a textile yarn made, for example, of nylon, polyester, or cotton, that has been impregnated or chemically bonded with silver, copper, annealed copper, gold, aluminum, rhodium, tungsten, zinc, cobalt, cadmium, nickel, lithium, iron, platinum, palladium, tin, or other known conductive or semi-conductive material. Such conductive textile yarns are preferable in that they can be used as thread and/or bobbin in industry standard textile and embroidery machines. Thus, a heating element can literally be “stitched” into the material of the carrier during fabrication. Moreover, conductive textile yarns are more preferable to metal or carbon fiber wires because they are much less prone to shedding or fracturing due to stress or shear forces during use.

In one preferred embodiment wherein the heated garment can include, for example, a heated glove, the heating element can be stitched using industry standard sewing machinery into the inner layer fabric of the finger sheaths prior to construction of a glove. The heating elements may be stitched into the inner fabric of the finger sheaths utilizing a single head stitching machine. However, a multi-head stitching machine is preferable since it can increase the production rates significantly. The heating elements also can be woven into the material of the finger sheaths of the inner layer, but this requires that conductive fabric yarns be used in looms and be incorporated at a significantly earlier stage of the manufacturing process. Although within the scope of the invention, the inventors do not consider this approach to be the best mode of carrying out the invention.

The heated glove system also includes, in addition to the glove with integrated heating elements, additional components such as a power supply, a controller, and connection terminals. The length and resistivity of the heating element can be determined to match a suitable power source, thereby optimizing performance of the heated glove. Various heating element characteristics can be utilized to optimize the resistivity of the heating element to match a preferred power supply voltage such as the number of heating elements, the lengths of heating elements, and the conductivity of heating elements. Moreover, during incorporation of heating elements into the interior fabric carrier, the stitch patterns of the heating elements can be customized to optimize the overall resistance of the heating element array. These patterns can then simply be pre-programmed into a stitching machine. For example, the heating elements may be incorporated in a side-by-side linear pattern or in a non-linear pattern such as, for instance, a sinusoidal block pattern, a zigzag pattern, or a triangular pattern. The heating elements also may be applied in a crossing pattern wherein heating elements cross over one another at intersections. This, as discussed above, creates areas of increased thermal energy that can increase the perception of warmth to a wearer without increasing the power consumption of the system.

In some embodiments, the heating elements are electrically coupled to terminals. It has been found that bare flat braded copper conductors are suitable for use as terminals. Generally, a heating element is first stitched into or onto a fabric carrier. Terminals are placed on the heating element at input and output locations and a second stitching secures the terminals to the heating element. It can be preferable to use a conductive or semi-conductive yarn or thread to stitch the terminal to the heating element and fabric carrier. A portion at the end of the terminals is typically left available for an electrical connector to attach to the power supply and controller to the heating element or elements. FIGS. 6A-6C illustrate a heating pad that incorporates stitched-in heating elements. The heating pad in the foreground has been stitched with conductive yarns that form a zigzag configuration. Each pair of conductive yarns in a row is electrically coupled via terminals to an input cable shown to the right of the image. The heating pad in the background in FIGS. 1-4D and 6A-6C illustrate various examples of heating elements embroidered or stitched into a crossing pattern wherein individual heating elements cross over one another at intersections to create areas of increased thermal energy.

With pads formed as described above, a plurality of finger sheaths for a glove may be fabricated by folding a portion of the carrier into a generally cylindrical or finger-shape and securing the edges to themselves. When so folded, the heating elements of each finger sheath extend substantially completely about the inner circumferential surface of the finger sheath. Such a configuration offers significant advantages over prior art heated glove designs. For example, in cold weather conditions, substantially the entirety of each finger within a corresponding finger sheath receives heat from the heating element within the sheath. This drastically reduces “cold spots” that can result in hypothermia and frostbite. Further, since the heat conveyed to a wearer's fingers is substantially uniform over the surfaces of the fingers, a wearer need not turn up the power just to warm parts of the fingers not covered by the heating elements. Such compensating practices in the past have lead in some cases to “hot spots” within a glove, which can burn a wearer's fingers and limit the degree to which the power can be increased. With the present invention, heat is conveyed uniformly to the fingers such that a higher supply voltage and thus a greater overall heat transfer can be used without creating hot spots that tend to overheat or burn a wearer's fingers.

Incorporated heating elements such as those just described can be subject to being cut, shorted, chafed, or exposed to moisture, oxidation, electrical discharges, harsh chemicals, or otherwise damaged by environmental hazards. This, in turn, can change the electrical properties of the heating elements resulting in erratic performance or outright failure. This is particularly true for gloves incorporating such heating elements because wearers often work with their hands in wet or harsh environments. Due to such hazards, it has been found advantageous to provide an additional level of protection for the stitched-in or stitched-on heating elements of heating pads. The inventors have discovered that this can be done by impregnating and/or laminating the heating pad with a resilient protective material such as for example a polymer, a plastic, or liquid silicone, to render the heating pad more resistant to environmental hazards.

Various methods have been developed that seal out air and moister from the fabricated structures. Lamination and impregnation have been utilized as effective means to protect the heating elements of heating pads from damage by physical damage, air, water, temperature, oxidation, electrical charge, electroplating, change in resistance, and other environmental hazards.

In preferred embodiments, the protective material comprises a liquid silicon that is applied and impregnated into the heating pad such as by rolling, spraying or other methods. Liquid silicones maintain full elasticity over a wide temperature range, and resist aging, ozone deterioration, harsh chemicals, and other hazards. In addition, liquid silicones provide good electrical insulation for the heating elements within the heating pad. Moreover, liquid silicones are less readily deteriorated by electromagnetic field exposure and radiation exposure than liquid plastics. In addition, unlike liquid plastics, liquid silicones have a high biological inertness. They are odorless, tasteless, do not support bacterial growth, and will not stain or corrode other materials.

In preferred embodiments, the heating pad is impregnated with a liquid silicone using a low pressure liquid injection molding impregnation technique. Liquid silicones have relatively low viscosities when compared with liquid plastics. Typically, viscosities for liquid silicones at the point of injection range from 500 to 1,000 Pa-s, while liquid plastic viscosities are normally between 5,000 to 10,000 Pa-s. This allows for much lower injection pressures during the injection impregnation process. The inner glove layer, which is the fabric carrier for the heating element, is placed in the cavity of an industry standard silicon injection molding and the injection molding machine is then closed. Liquid silicone and a catalyst that may comprise a platinum curing agent are transferred into the injection molding machine via a pneumatic pumping mechanism such as a gear pump or a worm pump. Various mixing ratios for the liquid silicone and the catalyst may be used; however, it has been found that the mixing ratio 1:1 provides good results. The liquid silicone and the catalyst are mixed via a static mixing device in the injection molding machine and injected under pressure into the cavity containing the heating pad.

Regulation of the injection pressure typically is required prior to introduction of the mixed material into an injection unit of the injection molding machine. Injection pressures may range between 100 psi and 1200 psi depending on process parameters such as the type of liquid silicone being used, the volume of liquid silicone, extrusion temperature, and the like. In preferred embodiments, injection pressures range between 100 psi and 500 psi, which has been found to prevent over-compression. The mixed material is fed into an inlet port on a barrel of the injection unit. The injection unit barrel typically is water cooled to prevent the friction and pressure from curing the mixed material prematurely within the barrel. Injection of the mixed material into the cavity is accomplished by utilizing a check valve at the end of a screw that is cylindrically wrapped around the barrel of the injection unit. Once in the cavity, the pressurized mixed material will then permeate the material of the heating pad that incorporates the heating elements. It is preferable that the injection molding machine also include a water-cooled shut-off nozzle to prevent the mixed material from back-flowing and prematurely catalyzing due to friction and pressure.

The mixed material is then cured in the cavity of the injection molding machine with the help of the catalyst, thereby impregnating the heating pad with silicone. Cavity temperatures during the curing process typically range between 300° F. and 600° F. and cure time typically ranges between 30 seconds and 5 minutes depending on process parameters. The cavity is then opened and the silicon impregnated heating pad, which will become an inner glove layer, is removed.

When using the silicone impregnated heating pad to fabricate a glove, the inner glove layer is attached to the outer glove layer by stitching using standard embroidery and stitching equipment. In some embodiments, the inner glove layer in stitched to the outer glove layer using a single head stitching machine. However, a multi-head stitching machine is preferable as such machine can increase the production rates per operator. The outer glove layer may consist of leather, brushed micro-fleece, rugged nylon or any other durable fabric chosen for the environment in which the glove will be used. It is preferable that the outer glove layer comprise rugged nylon, which is water and chemical resistant and resistant to puncture and other damage that can jeopardize the inner heating pad and heating elements.

The power source used to heat the heating elements may be a rechargeable battery, a non-rechargeable battery, an external power source, a direct current power source, or an alternating current power source. In some embodiments, such as shown in FIG. 3, the power source 29 for the power controller unit and heating element assemblies can be incorporated into or detachably connected to the thermal-regulated garment or apparel item, independent of the use of the electrical connections of the apparel controller unit. For example, the power source 29 can be a lithium-ion battery or similar replaceable and/or rechargeable power pack that fits into the garment and/or connects to or can be a part of the apparel controller unit, or still further, can include a connection to an electrical generator. Further, it is preferable that the power source be linked to a controller to control the current flow through the heating element and thereby control the heat generated within the glove by the heating element. Any appropriate controller capable of increasing or decreasing the voltage applied to the heating element may be used. Examples include sliding or rotary potentiometers, digital potentiometers, scheduled switches, or microcontrollers and related circuitry. In any case, the purpose of the controller is to control the power source to provide a constant, pulsed or periodic, or variable or non-variable voltage supply to the heating element to control and/or maintain the heat provided to the hand and fingers of a wearer, in the case of a glove.

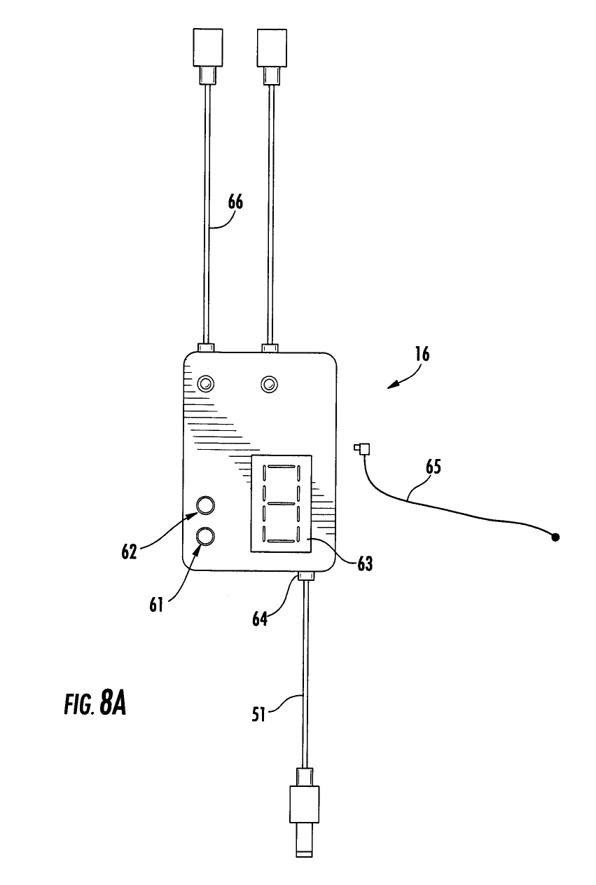

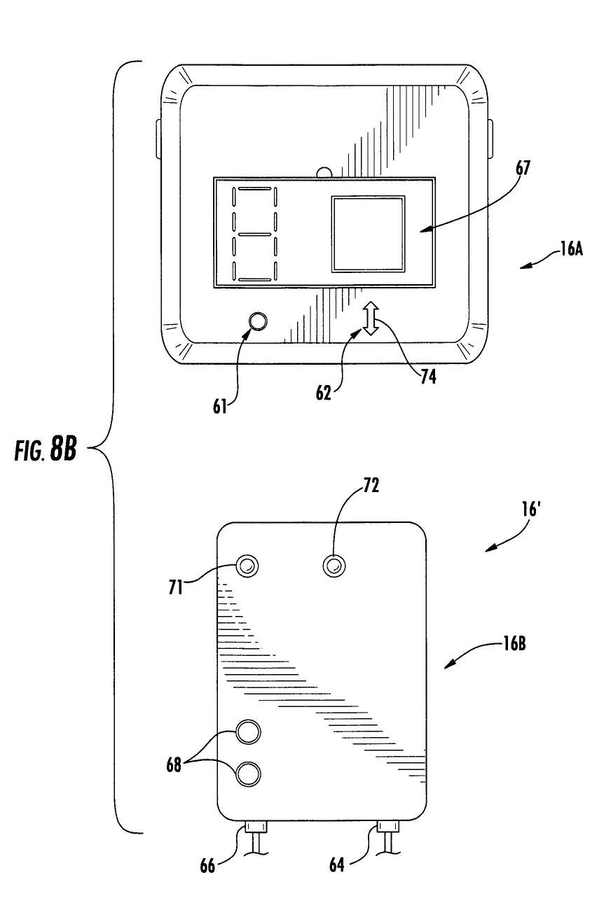

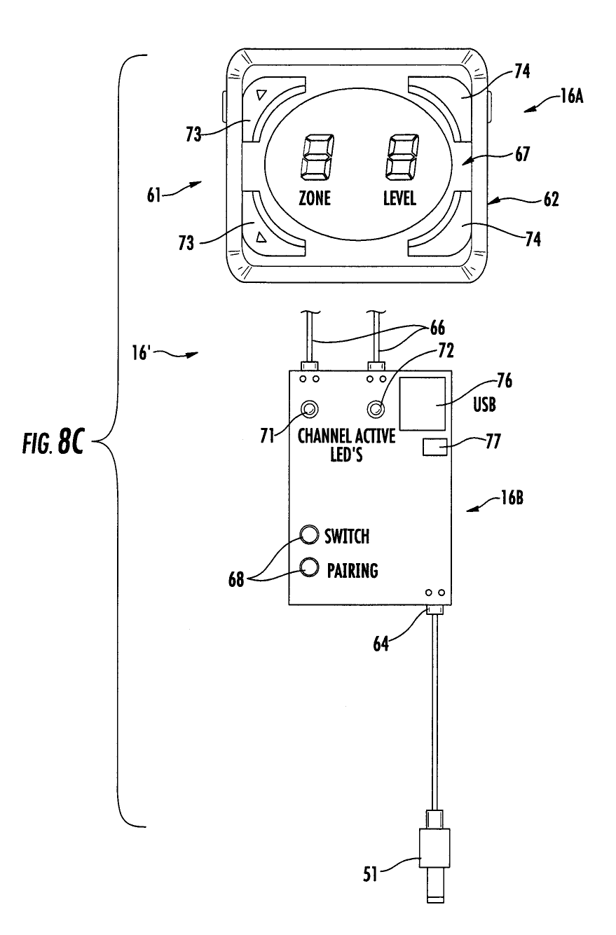

Referring to FIGS. 7-8C, various exemplary embodiments of an apparel controller unit 16, which can be integrated into a heated garment of device, and/or which can be separately connected thereto is shown. The apparel controller unit 16 shown in FIG. 8A can include two user/input controls 61/62, and a display 63, such as an LED, or similar indicator. A first user/input control 61 can comprise a user setting control and is configured to establish and transmit an electrical power output from an electrical power supply 64 to the heating devices controlled thereby via one or more electrical power outlet connectors 66. An additional connector 65 also can be provided for separately linking the apparel controller unit to another controller or autopilot control system as needed. The electrical power output can be continuously repeated at a predetermined amperage and also for a predetermined frequency and duration, depending on a setting input from the user. For example, at a desired heating level, the user can engage the first control to set the power level going forward.

The apparel controller unit 16 of FIG. 8A also can include a second input or user control 62. The second input or user control is capable of being engaged and disengaged by the user. It can be configured such that when it is initially engaged, a desired temperature or other measurable value that can be associated or correlated therewith can be determined and set. For example, an electrical resistance value of a sensor, such as a thermistor, can be measured, or alternatively, a voltage level of a thermocouple is measured. Such measured values can be shown on the display 63 as the user varies the power output to the heating assembly, to provide the user with a visual indicator (i.e., a numerical value of 1-9 or other indication) of a desired thermal output level based on measured temperature or resistance/voltage levels provided by a sensor 80 integrated with/into the heating device. The user can then fix or set a desired level. While the resistance value and/or voltage level is measured, as long as the second control is engaged, the setting of the first control is overridden. The electrical power output can be substantially automatically varied by the apparel controller unit such that the measured electrical resistance value of the thermistor or the voltage level of the thermocouple remains relatively constant with respect to the initially measured and set/predetermined values. In other words, the resistance value and/or voltage level is maintained within a predetermined range with respect to the initially measured values. When the second control is disengaged, the electrical power output returns to the last electrical power output setting established by the first control.

Referring to FIG. 8B, another exemplary apparel controller unit 16′ is shown, including two sections or parts 16A/16B. In this embodiment, the apparel controller unit 16 can include a transmitter section 16A and a base or receiver section 16B, although each part is capable of both transmitting and receiving wireless signals. The first part of the apparel controller unit, the wireless transmitter 16A can include the first input or user setting control 61, and also an auto pilot user control or a second input or user control 62. The base or receiver part 16B of the controller unit 16′, generally will include electrical input and output connections 64/66 from the power supply 62 as well as a display 67, such as an LED or LCD screen and to the power output connector and also can include a connection/pairing status indicator 68.

Referring to FIG. 8C, another exemplary apparel controller unit 16′ with two parts 16A/16B and two independent operating channels 71/72 is shown. The wireless transmitter part 16A can include two independent user setting controls, including the first user or input control, and an auto pilot control or second user or input control. In this embodiment, the first user or input control can include 2 or more buttons or switches 73 for enabling the user to switch between the 2 or more operating channels so as to enable control of multiple heating zones, for example multiple different parts, areas or locations of a heated garment, or for control of multiple linked garments, as shown in FIG. 6. The second user control likewise can comprise 2 or more buttons or switches 74 (FIG. 8C) or a single toggle switch 76 (as shown in FIG. 8B) or similar switch mechanism, to enable user adjustment of the thermal output of the heating elements for each garment or zone. The receiver includes one connection to the power supply. The receiver also can include two or more independently controlled power output connectors 66.

In some embodiments, the controller includes two or more electrical power outlet connectors, and also can include two or more first controls, each operating independently from the other. In some embodiments, the controller includes two or more second controls, each operating independently from the other. In some embodiments, the controller includes two or more electrical power outlet connectors, each operating independently from the other. In some embodiments, the controller includes two separable parts in wireless communication with each other, sometimes referred to as a transmitter and a receiver, although both components are capable of both transmitting and receiving wireless signals, and each including its own power supply or connection/power inlet connectors.

In addition, in embodiments where the apparel controller unit includes a wireless transmitter part/section 16A (FIGS. 8B-8C), this section or part 16A can be provided with an internal power source, such as replaceable and/or rechargeable batteries, so as to be rechargeable by replacement of the batteries therein or by mounting the part on a cradle of dock, and/or can also include auxiliary power/data port connections. Additionally, where multiple power outlet connectors are provided by the article controller unit, one connector can be attached to one apparel item and another connector can be connected to a second apparel item to separately power/heat each apparel item, and with each different apparel item being regulated independently from the other. In some embodiments, the thermistor or thermocouple is embedded within the thermal-regulated apparel item.

Additional objects of the general inventive concept include providing a method of heating and control of heat applied to an electrically-powered thermal-regulated apparel item. The method includes establishing an electrical power output from an electrical power source to an electrical power outlet connector in the controller as described above. In some embodiments, the method includes measuring the electrical resistance value of a thermistor or measuring a voltage level of a thermocouple and varying the electrical power output such that the resistance value or voltage level remains relatively constant with respect to the initially measured value/voltage level.

The electrical resistance of the heating element can be optimized to function with power supplies with a wide variety of voltage outputs. In some embodiments, the power supply produces a voltage between 7 and 7.5 volts and in others, the power supply produces a voltage between 11 and 15 volts. In yet other embodiments, the power supply may produce operating voltages between 22 and 28 volts or between 30 and 32 volts.

Traditional heated gloves tend to be problematic when coupled to a power supply that produces relatively high supply voltages between, for example, 22 and 32 volts. This is due in large part because such a scenario tends to produce hot spots within the gloves, which burn a wearer's fingers in some locations and leave the fingers cold in others. However, a heated glove according to the present invention ensures that heat is spread substantially evenly about a substantial inner circumference of each of the plurality of finger sheaths of the glove. This provides a much greater uniformity of heat applied to a wearer's fingers thus warming all portions of each finger and eliminating the need to “turn up the heat” to warm certain portions of the fingers while creating hot spots in other portions of the fingers. This is a distinct advantage when a wearer is exposed to extremely cold weather conditions for prolonged periods of time since higher operating voltages and thus more heat generation can be realized without the generation of internal hot spots with the gloves.

In preferred embodiments, it has been found advantageous to configure a sensor within a heated garment such as a glove to disconnect the power supply from the heating element in unsafe conditions. FIG. 7 illustrates an example heating circuit incorporating such a sensor 80. In one embodiment, a temperature sensor can be incorporated into the heating device or pad and can provide monitored feedback of actual received temperature along or at a desired location within the heated garment or apparel item.

In another example embodiment, such a sensor may include a thermistor or thermocouple located along the length of the heating element 20, as indicated in FIGS. 2-3. The thermistors or thermocouples used for the sensor 80 can include a variety of different types of thermistors, including substantially lower-cost thermistors or thermocouples, such as thermistors or thermocouples that can incorporate up to a 20% tolerance or margin with respect to electrical resistances or voltage levels measured thereby. In addition, the thermistors or thermocouples utilized do not have to be closely calibrated or selected for tight tolerances or correspondence with actual measured temperatures. Instead, the user or wearer can select or correlate a measured electrical resistance or measured voltage level value based on their own warmth/comfort level, so as to program or set the apparel controller unit to apply/adjust a power level at which a desired amount of heat or thermal output is applied by the garment based upon a theoretical heat transfer growth in view of the recorded electrical resistance or voltage level value or a range of values corresponding to such a desired, user preferred or prescribed thermal output. Thereafter, the apparel controller unit 16 can receive monitored or measured electrical resistance or voltage level values measured or detected by the one or more thermistors or thermocouples mounted within the heating pads or devices and adjust the thermal output of the heating devices accordingly.

Additionally, each heating device can further be configured to include a secondary controller that can record or detect such thermistor electrical resistance or thermocouple measured voltage level values at preset intervals and can communicate this information to the apparel controller unit, either substantially in real time as such measurements are being recorded, or at a further interval such as may be needed to conserve power of an internal power source or supply. Where multiple thermistor resistance or thermocouple voltage level measurements are provided, the apparel controller unit also can be configured to use such information, such as by averaging the received measured resistance values for the garment, or by display and/or control of the heating assemblies of the garment as separate zones, as indicated in FIG. 8C.

Additionally, the system can be configured to disconnect the power supply when a temperature of 110° Fahrenheit (or other predetermined/set temperature) is detected, either by actual temperature measurement or by a preset resistance/voltage level being detected, within the garment glove. Such a sensor can be provided as a safety measure to prevent a user's hands and fingers from overheating should the heating system malfunction. Alternatively, the conductive strand forming the heating element can be designed to break the circuit or “self-fuse” above a certain threshold temperature, thus breaking the circuit and terminating the heating of the heating element. For example, short fuse sections can be built into the heating element that “burn through” above a certain threshold current flow and thus temperature, thus breaking the path of conduction and shutting down further heating of the glove. It has been found that self-fusing heating elements designed to disconnect at moderate temperatures around 150 degrees Fahrenheit are desirable. A glove incorporating such an automatically fusing heating element can be significantly safer than gloves that do not incorporate such a feature.

Other exemplary embodiments may include the self-governing apparel item wherein the power source is a battery or replaceable/rechargeable power supply integrated into and/or removable from the garment or the apparel controller unit itself. In other embodiments, the power source will be an external source capable of detachably connecting to the self-governing apparel through an auxiliary port. Varied power source possibilities create design and engineering flexibility, which enables the present inventive concept to be tailored to variety of fields of use or recreational activities.

The foregoing and other objects are intended to be illustrative of the general inventive concept and are not meant in a limiting sense. Many possible embodiments of the invention may be made and will be readily evident upon a study of the entire specification and accompanying drawings comprising a part thereof. Various features and sub-combinations of the general inventive concept may be employed without reference to other features and sub-combinations.

The invention has been described herein with reference to certain exemplary embodiments that are believed by the inventors to represent the best mode of carrying out the invention. It will be understood by the skilled artisan, of course, that a wide variety of additions, deletions, and modifications, both subtle and gross, might well be made to the exemplary embodiments presented herein without departing from the spirit and scope of the invention, which is limited only by the claims.

What is claimed is:

1. A heated garment for use by a wearer to impart heat to the user in cold conditions, the heated garment comprising:
a wearable garment having an interior portion;
at least one heating pad in the wearable garment configured, when heated, to radiate heat from the interior portion of the garment to a wearer of the garment;
the heating pad comprising at least one heating element fixed to a carrier, the heating element being configured on the carrier such that, when heated, the heating element produces on the carrier a plurality of areas of increased thermal energy relative to other areas on the carrier;
a source of electrical power arranged to supply operating voltage to the heating element when heat is desired.

2. The heated garment of claim 1 wherein the at least one heating element is configured such that the heating element crosses over itself to produce the plurality of areas of increased thermal energy within the areas of increased thermal output.

3. The heated garment of claim 1 wherein the at least one heating element is configured such that the heating element comes into close proximity to itself to produce the plurality of areas of increased thermal energy.

4. The heated garment of claim 1 further comprising a plurality of heating pads located at different locations within the garment to apply heat to selected areas of the body of the wearer.

5. The heated garment of claim 1 further comprising an insulating material impregnating the carrier.

6. The heated garment of claim 5 wherein the insulating material comprises a polymer.

7. The heated garment of claim 5 wherein the insulating material comprises a plastic.

8. The heated garment of claim 5 wherein the insulating material comprises a silicone.

9. The heated garment of claim 8 wherein the silicone impregnates the heating pad to protect and insulate the heating element.

10. The heated garment of claim 1 wherein the heating pad forms the inner lining of the garment.

11. The heated garment of claim 10 wherein the garment is a glove having finger sheaths and the heating pad carries a heating element configured to surround substantially the entire outer periphery of the finger sheaths.

12. The heated garment of claim 1 further comprising a power supply capable of supplying an operating voltage to the heating element to cause the heating element to conduct current and be warmed.

13. The heated garment of claim 12 further comprising a controller coupled to the power supply, the controller being configured to vary at least one characteristic of the operating voltage in order to control the warmth of the heating element.

14. The heated garment of claim 13 wherein the at least one characteristic is selected from a group consisting essentially of voltage level, on-duration, and off-duration.

15. A pad configured to be incorporated in a garment to convey heat to the body of a wearer of the garment, the pad comprising:
a carrier being sufficiently flexible to move with a wearer's body;
a heating element incorporated into the carrier, the heating element warming in response to application of an operating voltage to the heating element;
the heating element being arranged on the carrier to produce a field of warmth characterized by isolated areas of increased thermal energy in response to application of the operating voltage.

16. The pad of claim 15 wherein the heating element comprises an elongated conductive strand having a predetermined resistance per unit length.

17. The pad of claim 16 wherein the strand is arranged on the carrier to cross over itself at the isolated areas to increase the thermal mass and thus thermal energy within the isolated areas.

18. The pad of claim 17 further comprising a protective material incorporated into the carrier to protect the heating element from environmental hazards.

19. The pad of claim 18 wherein the protective material comprises a polymer.

20. The pad of claim 18 wherein the protective material comprises a silicone.

21. The pad of claim 20 wherein the silicone is impregnated into the material of the carrier to surround and protecting the heating element incorporated therein.

22. The pad of claim 15 wherein the heating element comprises an elongated wire.

23. The pad of claim 15 wherein the heating element comprises conductive yarn sewn into the fabric of the carrier.
